(19) United States
(12) Patent Application Publication
(10) Pub. No.: US 2026/0292368 A1
(43) Pub. Date: Sep. 24, 2026

(54) PIXEL CIRCUIT AND IMAGE SENSOR INCLUDING DIFFERENTIAL AMPLIFIER

(71) Applicant: SAMSUNG ELECTRONICS CO., LTD., Suwon-si (KR)

(72) Inventors: Junoh KIM, Suwon-si (KR); Haewon LEE, Suwon-si (KR)

(73) Assignee: SAMSUNG ELECTRONICS CO., LTD., Suwon-si (KR)

(21) Appl. No.: 19/530,844

(22) Filed: Feb. 5, 2026

(30) Foreign Application Priority Data
Mar. 21, 2025 (KR) 10-2025-0036841

(51) Int. Cl. H04N 25/778; H04N 25/709; H04N 25/78

(52) U.S. Cl. CPC H04N 25/778; H04N 25/709; H04N 25/78

(57) ABSTRACT

An image sensor is provided. The image sensor comprises a pixel array comprising a plurality of pixel circuits configured to convert an optical signal into a pixel signal and output the pixel signal, and a readout circuit comprising an analog-to-digital conversion circuit configured to convert the pixel signal into digital data and output the digital data. Each of the plurality of pixel circuits comprises a photo detection circuit comprising a photoelectric conversion element, a first node, a transfer transistor configured to electrically connect the photoelectric conversion element and the first node, and a reset transistor configured to electrically connect the first node and a reset voltage node, a second node connected to the first node through a first transistor, and a differential amplifier circuit comprising a second transistor having comprising a gate terminal connected to the first node, a third transistor having comprising a gate terminal connected to the second node, and a fourth transistor connected to a common source node connected to a source node of each of the first transistor and the second transistor.

### CROSS-REFERENCE TO RELATED APPLICATION

This application claims priority to Korean Patent Application No. 10-2025-0036841, filed on Mar. 21, 2025, the disclosure of which is herein incorporated by reference in its entirety.

### BACKGROUND

### 1. Field

One or more embodiments of the present disclosure relates to a pixel circuit and an image sensor, and more particularly, to a pixel circuit and an image sensor, each including a differential amplifier.

### 2. Description of Related Art

An image sensor may include a two-dimensional array with a plurality of pixels arranged therein. In general, each pixel circuit may include a single photodiode and four pixel transistors. A pixel circuit may be structured to use transistors (e.g., four) to optimize a circuit that outputs exact voltage of the floating node.

There may be limitations, under low-illuminance conditions, of increasing conversion gain by significantly reducing parasitic capacitance at a floating node to improve performance

### SUMMARY

One or more embodiments of the present disclosure include a pixel circuit and an image sensor, each including a differential amplifier configured to amplify a pixel signal.

According to an aspect of one or more embodiments, an image sensor may comprise a pixel array comprising a plurality of pixel circuits configured to convert an optical signal into a pixel signal and output the pixel signal; and a readout circuit comprising an analog-to-digital conversion circuit configured to convert the pixel signal into digital data and output the digital data. Each of the plurality of pixel circuits may comprise a photo detection circuit comprising a photoelectric conversion element, a first node, a transfer transistor is configured to electrically connect the photoelectric conversion element and the first node, and a reset transistor configured to electrically connect the first node and a reset voltage node; a second node connected to the first node through a first transistor; and a differential amplifier circuit comprising a second transistor having comprising a gate terminal connected to the first node, a third transistor having comprising a gate terminal connected to the second node, and a fourth transistor connected to a common source node connected to a source node of each of the first transistor and the second transistor.

According to an aspect of the one or more embodiments, another image sensor may comprise a pixel array comprising a plurality of pixel circuits configured to convert an optical signal into a pixel signal and output the pixel signal; a readout circuit comprising an analog-to-digital conversion circuit configured to convert the pixel signal into digital data and output the digital data; and a timing controller configured to control the pixel array based on a mode control signal received from an external device. Each of the plurality of pixel circuits may comprise a photo detection circuit comprising a photoelectric conversion element, a first node, a reset transistor configured to electrically connect the first node and a reset voltage node, and a transfer transistor configured to electrically connect the photoelectric conversion element and the first node; a second node connected to the first node through a first transistor; and a differential amplifier circuit configured to, in a first mode, receive a first input signal based on a first voltage signal of the first node and a second input signal based on a second voltage signal of the second node and output a first pixel signal based on a difference between the first input signal and the second input signal, and in a second mode, output the first voltage signal of the first node as a second pixel signal.

According to an aspect of one or more embodiments, a pixel circuit may comprise a photo detection circuit comprising a photoelectric conversion element, a first node, a transfer transistor configured to electrically connect the photoelectric conversion element and the first node, and a reset transistor configured to electrically connect the first node and a reset voltage node; a second node electrically connected to the first node through a first transistor; and a differential amplifier circuit comprising a second transistor having a gate terminal connected to the first node, a third transistor having a gate terminal connected to the second node, and a fourth transistor connected to a common source node connected to a source node of each of the first transistor and the second transistor.

### BRIEF DESCRIPTION OF DRAWINGS

Various techniques will be described with reference to the drawings, in which:

FIG. 1 is an example diagram illustrating an image sensor according to one or more embodiments;

FIG. 2 is an example diagram illustrating a pixel circuit and a readout circuit according to one or more embodiments;

FIG. 3 is an example circuit diagram illustrating a photo detection circuit according to one or more embodiments;

FIG. 4 is an example circuit diagram illustrating a differential amplifier circuit, an active load circuit, and a bias current circuit according to one or more embodiments;

FIG. 5 is an example diagram illustrating a portion of the operation of an image sensor according to one or more embodiments;

FIG. 6 is an example diagram illustrating another portion of the operation of an image sensor according to one or more embodiments;

FIG. 7 is an example timing diagram illustrating the operation of an image sensor according to one or more embodiments;

FIG. 8 is an example circuit diagram illustrating an image sensor according to one or more embodiments according to one or more embodiments;

FIG. 9 is an example diagram illustrating the operation of the image sensor of FIG. 8 in a low-illuminance environment according to one or more embodiments;

FIG. 10 is an example diagram illustrating the operation of the image sensor of FIG. 8 in a high-illuminance environment according to one or more embodiments;

FIG. 11 is an example plan view illustrating an image sensor according to one or more embodiments according to one or more embodiments;

FIG. 12 is an example diagram illustrating an image sensor according to one or more embodiments according to one or more embodiments;

FIG. 13 is an example diagram illustrating an image sensor according to one or more embodiments according to one or more embodiments;

FIG. 14 is an example flowchart illustrating the operation of an image sensor according to one or more embodiments; and

FIG. 15 is an example diagram illustrating an imaging device according to one or more embodiments.

### DETAILED DESCRIPTION

The following description with reference to the accompanying drawings is provided to assist in a comprehensive understanding of one or more embodiments of the present disclosure.

Use of terms such as “a” and “an” and “the” and similar referents in context of describing disclosed embodiments (especially in context of following claims) are to be construed to cover both singular and plural, unless otherwise indicated herein or clearly contradicted by context, and not as a definition of a term.

As used herein, such an expression as “comprises,” “has,” “consists,” or “include,” or the like should not be interpreted to necessarily include all elements or all operations described in the specification, and should be interpreted to be allowed to exclude some of them or further include additional elements or operations.

Terms such as “first,” “second,” “third,” “fourth,” etc. are used merely to distinguish elements from one another and thus do not denote any particular order unless an order is specifically described. For example, the term “second” may be used without using the term “first”. Also, although the terms “first,” “second,” “third,” and so on may be used herein to describe various elements, components, regions, layers and/or sections, these elements, components, regions, layers and/or sections should not be limited by these terms.

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

Phrases of form such as “at least one of A, B, and C,” or “at least one of A, B or C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B or C” refer to any of following sets: {A}, {B}, {C}, {A, B}, {A, C}, {B, C}, {A, B, C}. Thus, such language is not generally intended to imply that certain embodiments require at least one of A, at least one of B and at least one of C each to be present.

Terms such as “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

In addition, unless otherwise noted or contradicted by context, term “plurality” indicates a state of being plural (e.g., “a plurality of items” indicates multiple items). Number of items in a plurality is at least two, but can be more when so indicated either explicitly or by context. Further, unless stated otherwise or otherwise clear from context, phrase “based on” means “based at least in part on” and not “based solely on.”

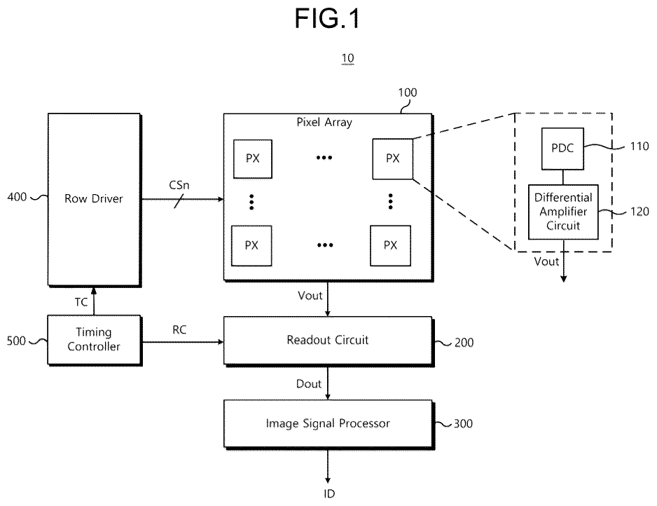

FIG. 1 is an example diagram illustrating an image sensor 10 according to one or more embodiments.

Referring to FIG. 1, the image sensor 10 may include a pixel array 100, a readout circuit 200, an image signal processor 300, a row driver 400, and a timing controller 500.

The pixel array 100 may include a plurality of pixel circuits PX. The plurality of pixel circuits PX included in the pixel array 100 may be arranged in a two-dimensional matrix.

The pixel circuit PX may generate a pixel signal Vout based on an optical signal received through a lens, a color filter, or the like, and output the generated pixel signal Vout to the readout circuit 200. The pixel signal Vout output by the pixel array 100 may be based on a voltage level corresponding to the received optical signal.

The pixel circuit PX may include a photo detection circuit 110 and a differential amplifier circuit 120.

The photo detection circuit 110 may include at least one photoelectric conversion element. The photo detection circuit 110 may receive an optical signal and output an analog signal corresponding to the optical signal. The analog signal output by the photo detection circuit 110 may be based on a voltage level.

The photoelectric conversion element may be a photodiode (PD). A photodiode (PD) may refer to a type of photoelectric conversion element configured to generate charges in proportion to the optical signal incident on each pixel and accumulate the generated charges.

The photoelectric conversion element may be one of a photodiode (PD), a photocapacitor, a photogate, a pinned photodiode (PPD), a partially pinned photodiode, an organic photodiode (OPD), a quantum dot (QD), or combinations thereof.

The following embodiments are described with the understanding that the photoelectric conversion element is a photodiode (PD). However, other photoelectric conversion elements described above may be used, and the photoelectric conversion element is not limited to a photodiode (PD).

The differential amplifier circuit 120 according to one or more embodiments may amplify the analog signal output by the photo detection circuit 110 to output the pixel signal Vout. For example, the differential amplifier circuit 120 may receive a first voltage signal V_FD based on the analog signal output by the photo detection circuit 110 and a second voltage signal V_RFD based on a reset voltage. The differential amplifier circuit 120 may generate and output the pixel signal Vout based on a difference in voltage levels between the first voltage signal V_FD and the second voltage signal V_RFD.

As described above, the pixel circuit PX according to one or more embodiments may include the differential amplifier circuit 120 to output a pixel signal Vout obtained by amplifying a difference in voltage levels between the first voltage signal V_FD and the second voltage signal V_RFD generated within the pixel circuit PX.

Accordingly, the pixel circuit PX may generate and output an amplified pixel signal Vout even in a low-illuminance environment, resulting in improved image quality in low-illuminance conditions.

Compared to when a reference voltage is received from an external node, the pixel circuit PX may improve PVT robustness such as process variation, voltage fluctuation, temperature variation, or the like. In addition, as a result of not being affected by physical factors such as parasitic capacitance of a metal interconnection connected to an external node, the pixel circuit PX may significantly reduce the effect of current-resistance (IR) voltage drop, noise, or the like.

The readout circuit 200 may include an analog-to-digital converter. The analog-to-digital converter included in the readout circuit 200 may convert the pixel signal Vout into a digital signal Dout and output the digital signal Dout.

For example, the analog-to-digital converter may sample the pixel signal using correlated double sampling and then convert the sampled pixel signal into a digital signal Dout. To this end, a correlated double sampling (CDS) logic circuit performing correlated double sampling may be further disposed at the front end of the analog-to-digital converter.

The analog-to-digital converter may perform reset level sampling for correlated double sampling based on the second voltage signal V_RFD and perform signal level sampling based on the first voltage signal V_FD.

The image signal processor (ISP) 300 may receive the digital signal Dout, perform image processing, and output image data ID. The image processing performed by the image signal processor 300 may include binning, cropping, remosaicing, noise reduction, white balance, color correction, sharpening, or the like.

However, this is only an example, and an image sensor 10 according to one or more embodiments may not include an image signal processor 300.

The row driver 400 may select a single row of the pixel array 100 under the control of the timing controller 500. The row driver 400 may generate a select signal CSn to select a single row among a plurality of rows. The row driver 400 may activate the pixel circuit PX corresponding to the selected row. The pixel signal Vout of the pixel circuit PX in the selected row may be transmitted to the analog-to-digital converter of the readout circuit 200.

The timing controller 500 may control the pixel array 100, the readout circuit 200, the image signal processor 300, and the row driver 400. In one or more embodiments, the timing controller 500 may provide a timing control signal TC to the row driver 400. In one or more embodiments, the timing controller 500 may provide a reference code RC to the readout circuit 200.

As described above, the image sensor 10 according to one or more embodiments may increase the conversion gain of the pixel circuit PX based on the differential amplifier circuit 120. As a result, the image sensor 10 may maintain a high signal-to-noise ratio SNR in spite of low-intensity optical signals in a low-illuminance environment.

The image sensor 10 may effectively detect and amplify even low-intensity optical signals, and thus may output image data having improved quality in low-illuminance environments.

The image sensor 10 may generate a second voltage signal V_RFD, a reference voltage used in the differential amplifier circuit 120, within the pixel circuit PX. Accordingly, the image sensor 10 may improve PVT reliability and may significantly reduce the effect of voltage drop and signal interference caused by metal interconnection.

As a result, the image sensor 10 may enhance image quality in low-illuminance environments while improving the reliability of the image.

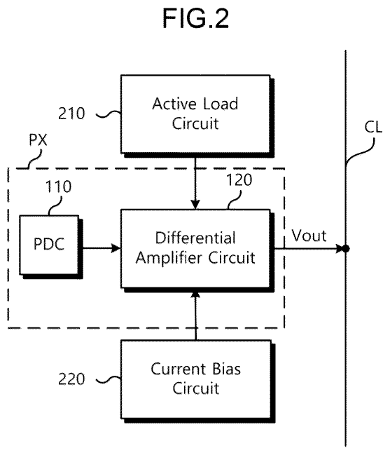

FIG. 2 is a diagram illustrating the pixel circuit PX and the readout circuit 200.

Referring to FIG. 2, the pixel circuit PX may include a photo detection circuit 110 and a differential amplifier circuit 120. Descriptions similar to or overlapping with those provided above are omitted for brevity.

The photo detection circuit 110 may receive an optical signal and output an analog signal corresponding to the optical signal. The analog signal output by the photo detection circuit 110 may be based on the amount of photocharges accumulated by the photodiode PD.

The differential amplifier circuit 120 may receive a first voltage signal V_FD based on the analog signal and a second voltage signal V_RFD based on a reset voltage. Then, the differential amplifier circuit 120 may amplify a difference in voltage levels between the first voltage signal V_FD and the second voltage signal V_RFD to generate a pixel signal Vout and output the generated pixel signal Vout through a column line CL.

The readout circuit 200 may further include an active load circuit 210 and a bias current circuit 220.

The active load circuit 210 may be electrically connected to the differential amplifier circuit 120 to provide a load resistance to the differential amplifier circuit 120. The load resistance provided by the active load circuit 210 may be used to allow the differential amplifier circuit 120 to amplify signals.

Gain of the differential amplifier circuit 120 may be calculated as a product of the transconductance of the differential amplifier circuit 120 and the load resistance. Therefore, the active load circuit 210 may contribute to increasing the gain of the differential amplifier circuit 120 by providing a high load resistance.

The active load circuit 210 may increase the output impedance of the differential amplifier circuit 120. When the output impedance of the differential amplifier circuit 120 increases, the effect of power supply voltage fluctuations on the output node may be reduced, resulting in decreased sensitivity to power supply noise.

The differential amplifier circuit 120 may receive load resistance from the active load circuit 210 to significantly reduce the effect of power supply noise caused by power supply voltage fluctuations and to increase a power supply rejection ratio PSRR of the differential amplifier circuit 120.

The bias current circuit 220 may provide a bias current to the differential amplifier circuit 120. The differential amplifier circuit 120 may stably operate based on the bias current provided by the bias current circuit 220.

The bias current provided by the bias current circuit 220 to the differential amplifier circuit 120 may improve the gain, linear operation, and noise-related performance of the differential amplifier circuit 120.

For example, the bias current circuit 220 may provide a constant bias current to the differential amplifier circuit 120, and the differential amplifier circuit 120 may stably operate in a linear region without variability with minimal signal distortion.

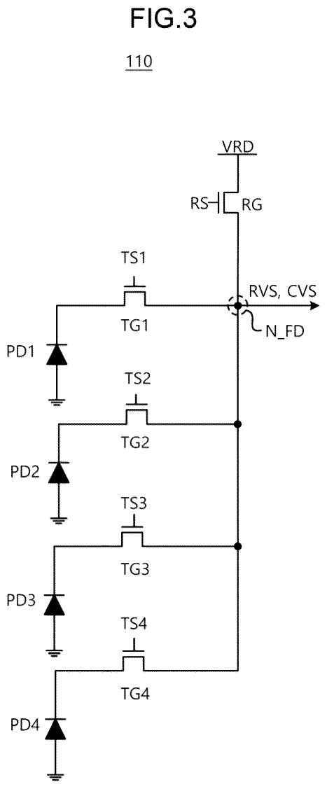

FIG. 3 is an example circuit diagram illustrating the photo detection circuit 110.

Referring to FIG. 3, the photo detection circuit 110 may include a plurality of photodiodes PD1, PD2, PD3, and PD4, a reset transistor RG, and a plurality of transfer transistors TG1, TG2, TG3, and TG4.

The plurality of photodiodes PD1, PD2, PD3, and PD4 may be exposed to light and receive optical signals. The plurality of photodiodes PD1, PD2, PD3, and PD4 may generate photocharges corresponding to the optical signals and accumulate the generated photocharges.

The reset transistor RG may connect a reset voltage VRD to a floating node N_FD and reset the floating node N_FD based on a reset control signal RS. When the reset transistor RG is turned on, a voltage signal RVS based on the reset voltage VRD level may be output from the floating node N_FD.

Hereinafter, the reset control signal RS may be referred to as a first control signal, and the floating node N_FD may be referred to as a first node.

The plurality of transfer transistors TG1, TG2, TG3, and TG4 may control charge transfer between each of the plurality of photodiodes PD1, PD2, PD3, and PD4 and the first node N_FD based on transfer control signals TS1, TS2, TS3, and TS4. Hereinafter, the transfer control signals TS1, TS2, TS3, and TS4 may be referred to as second control signals TS1, TS2, TS3, and TS4.

The photo detection circuit 110 according to one or more embodiments may allow four photodiodes PD1, PD2, PD3, and PD4 to share the first node N_FD and the reset transistor RG.

In one or more embodiments, each of the transfer transistors TG1, TG2, TG3, and TG4 may be turned on at different times, and each of the four photodiodes PD1, PD2, PD3, and PD4 may individually output a voltage signal CVS based on the accumulated photocharge from the first node N_FD.

In one or more embodiments, each of the transfer transistors TG1, TG2, TG3, and TG4 may be simultaneously turned on, and all four photodiodes PD1, PD2, PD3, and PD4 may simultaneously transmit a voltage signal CVS to the first node N_FD.

However, the photo detection circuit 110 according to the embodiment of FIG. 3 is only an implementation example, and the implementation example of the photo detection circuit 110 is not limited to the embodiment of FIG. 2.

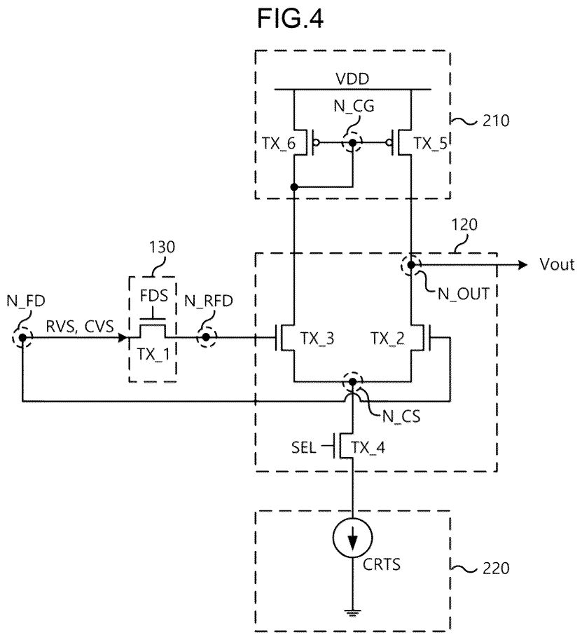

FIG. 4 is a circuit diagram illustrating the operation of the pixel circuit PX.

Referring to FIG. 4, the pixel circuit PX may include a first transistor (TX_1) 130 and a differential amplifier circuit 120.

In one or more embodiments, the first transistor 130 may be an N-type metal oxide semiconductor (NMOS) transistor. Hereinafter, an example is provided in which the first transistor 130 is an NMOS transistor. However, embodiments are not limited thereto.

A drain node of the first transistor 130 may be electrically connected to a first node N_FD.

A source node of the first transistor 130 may be electrically connected to a gate node of a second transistor TX_2. Hereinafter, the source node of the first transistor 130 may be referred to as a second node N_RFD.

The first transistor 130 may receive a third control signal FDS through a gate node of the first transistor 130. For example, the first transistor 130 may be turned on or turned off based on a third control signal FDS.

For example, when the voltage level of the third control signal FDS is high, the first transistor 130 may be turned on. The first node N_FD and the second node N_RFD may be electrically connected, resulting in the same voltage level at the first node N_FD and the second node N_RFD.

When the voltage level of the third control signal FDS is low, the first transistor 130 may be turned off. The first node N_FD and the second node N_RFD may be electrically disconnected.

In one or more embodiments, the first transistor 130 may generate the second voltage signal V_RFD by transitioning from an ON state to an OFF state.

When the first transistor 130 is turned on, the voltage level at the second node N_RFD may be equal to the voltage level at the first node N_FD. Then, when the first transistor 130 is turned off, the first node N_FD and the second node N_RFD may be electrically disconnected.

The second voltage signal V_RFD may be a signal based on the voltage level at the second node N_RFD when a first time has elapsed after the turn-off of the first transistor 130. The first time may be a predetermined time required for the voltage level of the second voltage signal V_RFD to stabilize.

The differential amplifier circuit 120 may include a second transistor TX_2, a third transistor TX_3, and a fourth transistor TX_4.

In one or more embodiments, the second transistor TX_2 may be an NMOS transistor.

The gate node of the second transistor TX_2 may be electrically connected to the first node N_FD. Accordingly, the first voltage signal V_FD may be input to a gate node of the second transistor TX_2 as a first input signal of the differential amplifier circuit 120.

A drain node of the second transistor TX_2 may be electrically connected to the active load circuit 210. Accordingly, the second transistor TX_2 may receive a load resistance from the active load circuit 210 through the drain node of the second transistor TX_2. The drain node of the second transistor TX_2 may be electrically connected to an output node N_OUT of the differential amplifier circuit 120.

A source node of the second transistor TX_2 may be electrically connected to a source node of the third transistor TX_3 through a common source node N_CS.

In one or more embodiments, the third transistor TX_3 may be an NMOS transistor.

A gate node of the third transistor TX_3 may be electrically connected to the second node N_RFD. Accordingly, the second voltage signal V_RFD may be input to the gate node of the second transistor TX_2 as a second input signal of the differential amplifier circuit 120.

A drain node of the third transistor TX_3 may be electrically connected to the active load circuit 210. Accordingly, the third transistor TX_3 may receive a load resistance from the active load circuit 210 through the drain node of the third transistor TX_3.

The source node of the third transistor TX_3 may be electrically connected to the source node of the second transistor TX_2 through the common source node N_CS.

A drain node of the fourth transistor TX_4 may be electrically connected to the common source node N_CS.

A source node of the fourth transistor TX_4 may be electrically connected to the bias current circuit 220. Accordingly, the fourth transistor TX_4 may receive a bias current from the bias current circuit 220 through the source node of the fourth transistor TX_4.

The fourth transistor TX_4 may receive a select signal SEL through a gate node of the fourth transistor TX_4. A constant bias current may flow through the fourth transistor TX_4 turned on by the select signal SEL, enabling the differential amplifier circuit 120 to operate. Accordingly, the fourth transistor TX_4 may determine whether to output the pixel signal Vout, based on the select signal SEL.

In one or more embodiments, the active load circuit 210 may include a fifth transistor TX_5 and a sixth transistor TX_6. The fifth transistor TX_5 and the sixth transistor TX_6 included in the active load circuit 210 may be P-type metal oxide semiconductor (PMOS) transistors.

A power supply voltage VDD may be applied to the source node of the fifth transistor TX_5. A gate node of the fifth transistor TX_5 may be electrically connected to a gate node of the sixth transistor TX_6 through a common gate node N_CG. A drain node of the fifth transistor TX_5 may be electrically connected to the second transistor TX_2.

A power supply voltage VDD may be applied to a source node of the sixth transistor TX_6. The gate node of the sixth transistor TX_6 may be electrically connected to a drain node of the sixth transistor TX_6 and the gate node of the fifth transistor TX_5 through the common gate node N_CG. The drain node of the sixth transistor TX_6 may be electrically connected to the third transistor TX_3.

In one or more embodiments, the fifth transistor TX_5 and the sixth transistor TX_6 may form a current mirror.

A gate voltage and a drain voltage of the sixth transistor TX_6 may be the same as the power supply voltage VDD. Accordingly, the sixth transistor TX_6 may operate in a saturation region.

The fifth transistor TX_5 and the sixth transistor TX_6 may share a gate node. Accordingly, the fifth transistor TX_5 may form the same gate-source voltage as the sixth transistor TX_6. As a result, the same current may flow through the fifth transistor TX_5 as through the sixth transistor TX_6.

The gate node and the drain node of the sixth transistor TX_6 are electrically connected, so that the sixth transistor TX_6 may always operate in the saturation region. The sixth transistor TX_6 shares the gate node with the fifth transistor TX_5, so that a gate-source voltage of the sixth transistor TX_6 may be equivalently applied to the fifth transistor TX_5.

The amount of drain currents of the fifth and sixth transistors TX_5 and TX_6 are maintained significantly small because the fifth and sixth transistors TX_5 and TX_6 operate in the saturation region, as described above. A load resistance provided by the fifth transistor TX_5 and the sixth transistor TX_6 may be inversely proportional to the amount of drain current flowing through a drain node of each transistor.

As a result, the load resistance provided by the fifth transistor TX_5 and the sixth transistor TX_6 may be maintained significantly high.

In one or more embodiments, the bias current circuit 220 may include a current source CRTS. Accordingly, the bias current circuit 220 may provide a constant bias current to the differential amplifier circuit 120.

As described above, the differential amplifier circuit 120 may receive the bias current provided by the bias current circuit 220 through the fourth transistor TX_4. Then, the differential amplifier circuit 120 may perform an amplification operation by distributing the bias current based on the voltage level difference between the first voltage signal V_FD input through the second transistor TX_2 and the second voltage signal V_RFD input through the third transistor TX_3. The load resistance provided by the active load circuit 210 may be used in an amplification operation.

An example is provided in which the first voltage difference has a greater voltage level difference than the second voltage difference. When the second voltage signal V_RFD has a voltage level difference from the first voltage signal V_FD corresponding to the first voltage difference, the amount of distributed bias current flowing through the first transistor TX_1 may be decreased, while the amount of distributed bias current flowing through the second transistor TX_2 may be increased.

When the second voltage signal V_RFD has a voltage level difference greater than the first voltage signal V_FD by the second voltage difference, a decrease in the amount of distributed bias current flowing through the first transistor TX_1 may be less than when the voltage level difference is the first voltage difference. In addition, the increase in the amount of distributed bias current flowing through the second transistor TX_2 may become larger.

When the active load circuit 210 provides a high load resistance, the change in the amount of current flowing through the first transistor TX_1 and the second transistor TX_2 may be converted into a voltage change based on Ohm's law V=IR. Furthermore, the load resistance provided by the active load circuit 210 may increase the gain of the differential amplifier circuit 120, so that a change in the voltage may be amplified more than an actual voltage level difference.

For example, the voltage level difference between the first voltage signal V_FD and the second voltage signal V_RFD may be amplified and output as the pixel signal Vout.

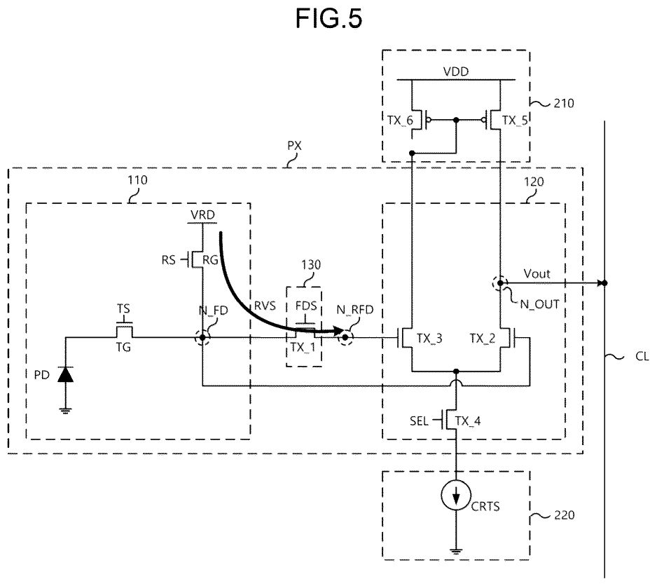

FIG. 5 is a diagram illustrating a portion of the operation of the image sensor 10.

In a non-limiting example, FIG. 5 illustrates the photo detection circuit 110 including a single photodiode PD.

Referring to FIG. 5, the reset transistor RG may receive the first control signal RS through a gate node of the reset transistor RG.

The reset transistor RG may be turned on based on the first control signal RS. Accordingly, a voltage level at the first node N_FD may be controlled based on the reset voltage VRD, and a voltage signal RVS may be output through the first node N_FD. The voltage signal RVS may be based on the voltage level of the reset voltage VRD. After a predetermined time has elapsed, the reset transistor RG may be turned off again based on the first control signal RS.

While the first transistor 130 is turned on, the reset transistor RG may be turned on. When the first transistor 130 is turned on, the second node N_RFD may be electrically connected to the first node N_FD. A voltage level at the second node N_RFD may be the same as that of the first node N_FD. Accordingly, the second node N_RFD may be reset by the reset voltage VRD in the same manner as the first node N_FD.

The first transistor 130 may be turned off based on the third control signal FDS after the reset transistor RG is turned off and a predetermined time has elapsed.

The second voltage signal V_RFD may correspond to the voltage of the second node N_RFD after the first transistor 130 is turned off and a first time has elapsed.

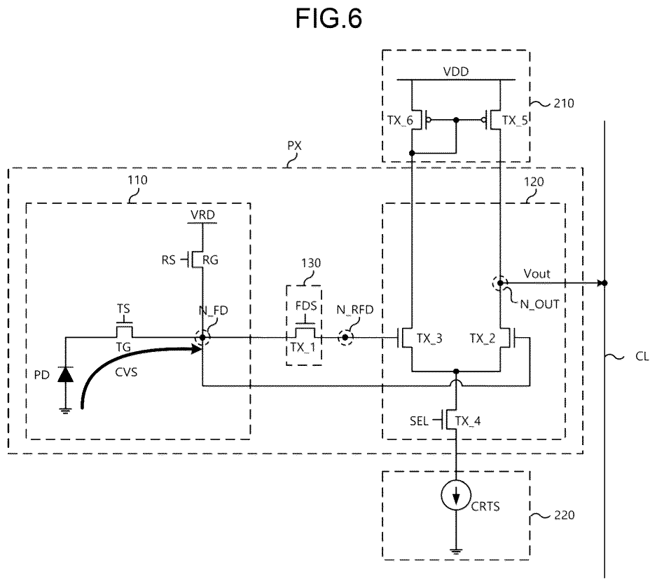

FIG. 6 is a diagram illustrating another portion of the operation of the image sensor 10.

Referring to FIG. 6, when the second voltage signal V_RFD is generated, the first transistor 130 may be in an OFF state. Accordingly, the first node N_FD and the second node N_RFD may be electrically disconnected.

After a predetermined time has elapsed while the first transistor 130 is turned off, the transfer transistor TG may receive the second control signal TS through a gate node of the transfer transistor TG. The transfer transistor TG may be turned on.

Accordingly, a voltage signal CVS corresponding to the photocharge accumulated in the photodiode PD may be transferred to the first node N_FD. Accordingly, the voltage level of the first voltage signal V_FD output through the first node N_FD may be controlled based on the optical signal received by the photodiode PD.

The transfer transistor TG may be turned off based on the second control signal TS after a predetermined time has elapsed while in an ON state.

As a result, the voltage of the first node N_FD may be controlled based on the voltage signal CVS of the photodiode PD. The first voltage signal V_FD may correspond to the voltage of the first node N_FD after the transfer transistor TG is turned off and a second time has elapsed.

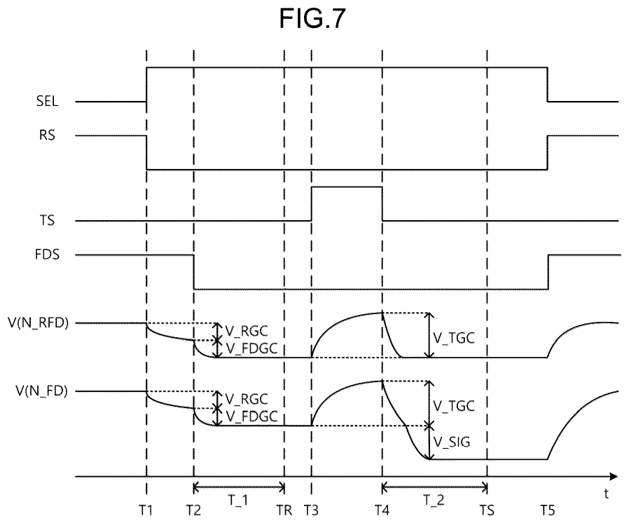

FIG. 7 is a timing diagram illustrating the operation of the image sensor 10. Descriptions similar to or overlapping with those provided with reference to FIGS. 5 and 6 are omitted for brevity.

Referring to FIG. 7, prior to time T1, the reset transistor RG may be in an ON state due to a high-level first control signal RS. In addition, the transfer transistor TG may be in an OFF state due to a low-level second control signal TS. In addition, the first transistor 130 may be in an ON state due to a high-level third control signal FDS.

At time T1, the first control signal RS may transition to a low level. Accordingly, the reset transistor RG may be turned off. Simultaneously or shortly before or after, the third transistor TX_3 may receive a select signal SEL.

The level of a voltage V(N_FD) at the first node N_FD and the level of a voltage V(N_RFD) at the second node N_RFD may drop by a first voltage difference V_RGC. The voltage drop may be attributed to the coupling capacitance between the reset transistor RG and the first node N_FD, and between the reset transistor RG and the second node N_RFD, based on the turn-off operation of the reset transistor RG.

At time T2, the third control signal FDS may transition to a low level. Accordingly, the first transistor 130 may be turned off to electrically disconnect the first node N_FD and the second node N_RFD.

The voltage levels of VN_FD and VN_RFD may drop by a second voltage difference V_FDGC. This voltage drop may be attributed to the coupling capacitance between the first transistor 130 and the first node N_FD, and between the first transistor 130 and the second node N_RFD, based on the turn-off operation of the first transistor 130.

In one or more embodiments, a coupling capacitance between the first transistor 130 and the first node N_FD and a coupling capacitance between the first transistor 130 and the reset transistor RG may be substantially the same. This may result in uniform voltage distribution among the first transistor 130, the first node N_FD, and the reset transistor RG, allowing the operation of the pixel circuit PX to be consistent.

At time TR, reset level sampling used for correlated double sampling (CDS) by the readout circuit 200 may be performed. A time interval from T2 to TR may correspond to the first time T_1.

At time T3, the second control signal TS may transition to a high level. Accordingly, the transfer transistor TG may be turned on to transfer the voltage signal CVS to the first node N_FD through the first node N_FD.

The voltage levels of VN_FD and VN_RFD may rise by a third voltage difference V_TGC. The voltage rise may be attributed to the coupling capacitance between the transfer transistor TG and the first node N_FD, and between the transfer transistor TG and the second node N_RFD, based on the turn-on operation of the transfer transistor TG.

At time T4, the second control signal TS may transition to a low level. Accordingly, the transfer transistor TG may be turned off.

The voltage level of VN_RFD may drop by the third voltage difference V_TGC. The voltage drop may be attributed to the coupling capacitance between the transfer transistor TG and the first node N_FD and the coupling capacitance between the transfer transistor TG and the second node N_RFD, based on the turn-off operation of the transfer transistor TG.

In addition, the voltage level of VN_FD may drop by the sum of V_TGC and V_SIG. The voltage drop may be attributed to the coupling capacitance and the voltage signal CVS based on the turn-off operation of the transfer transistor TG.

At time TS, signal level sampling for CDS by the readout circuit 200 may be performed. A time interval from T4 to TS may correspond to the second time T_2.

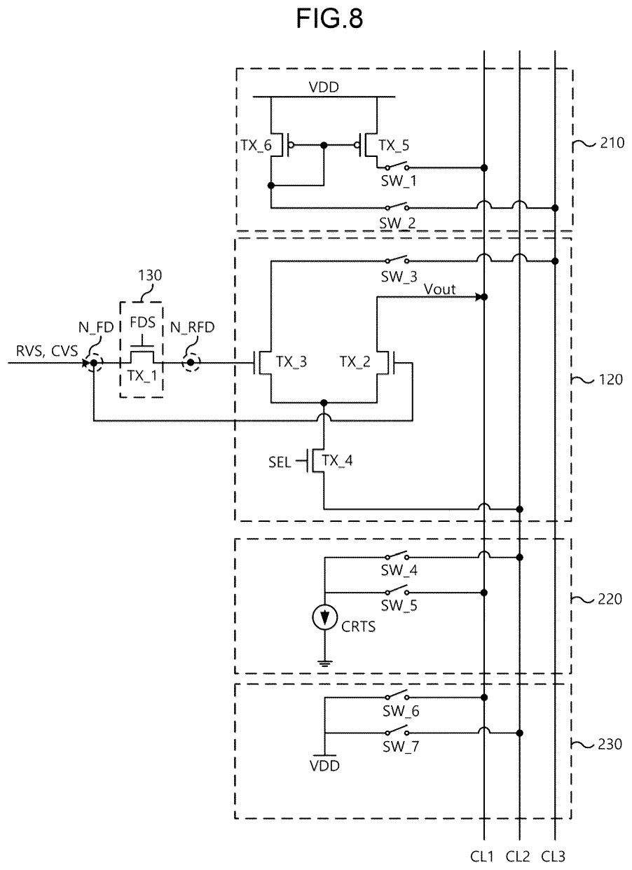

FIG. 8 is a circuit diagram illustrating the image sensor 10 according to one or more embodiments.

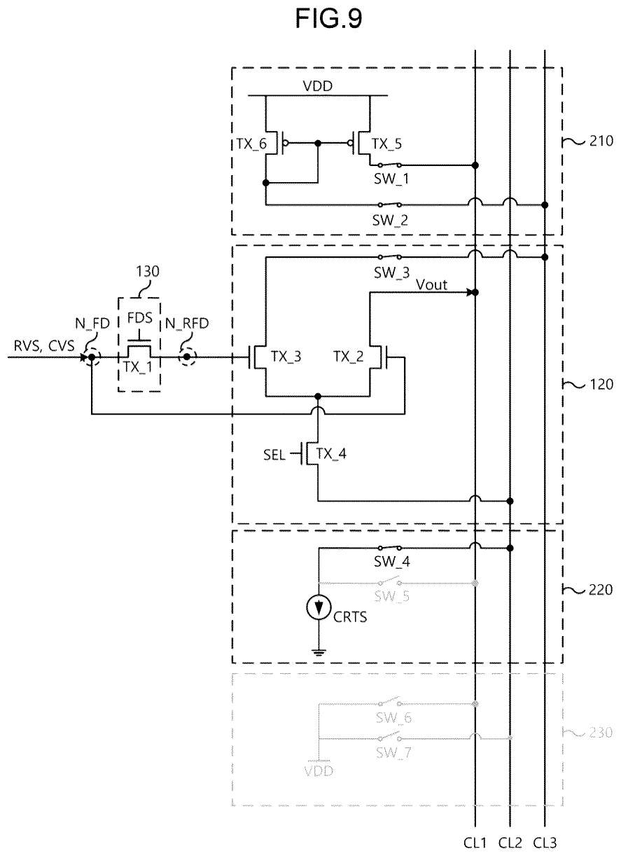

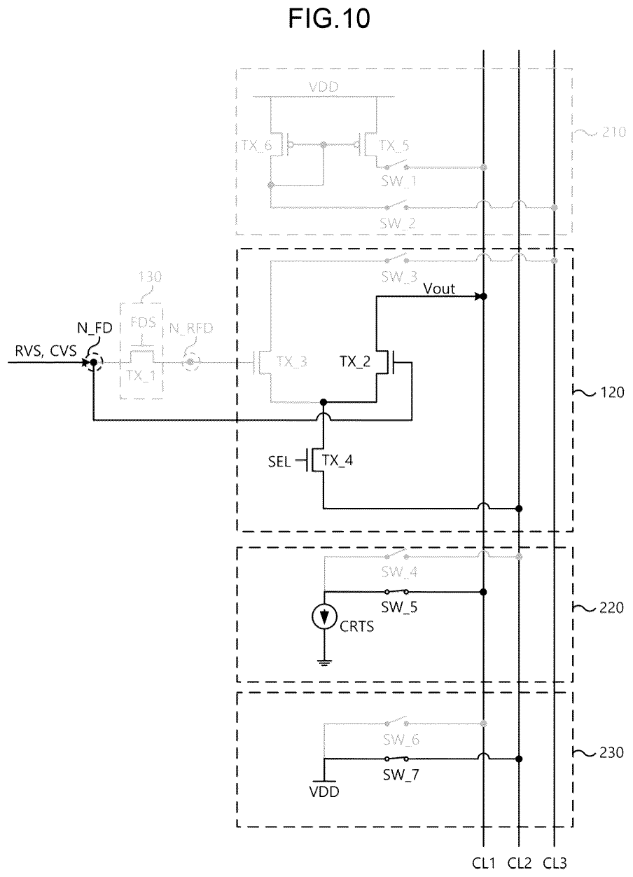

Referring to FIG. 8, a pixel circuit PX according to one or more embodiments may output a pixel signal Vout through first to third column lines CL1, CL2, and CL3, selectively receive a load resistance, or selectively receive a bias current and/or a power supply voltage depending on examples described in conjunction with at least FIGS. 9-10.

In one or more embodiments, the first column line CL1 may be a column line electrically connected to the second transistor TX_2 to output the pixel signal Vout. The second column line CL2 may be a column line to receive a bias current from the bias current circuit 220. The third column line CL3 may be a column line to receive a load resistance from the active load circuit 210.

In one or more embodiments, the differential amplifier circuit 120 may further include a switch SW_3 having one end, electrically connected to the third transistor TX_3, and another end electrically connected to the third column line CL3.

In one or more embodiments, the active load circuit 210 may further include a switch SW_1 having one end, electrically connected to the fifth transistor TX_5, and another end electrically connected to the first column line CL1. In addition, the active load circuit 210 may further include a switch SW_2 having one end, electrically connected to the sixth transistor TX_6, and another end electrically connected to the third column line CL3.

In one or more embodiments, the bias current circuit 220 may further include a switch SW_4 having one end, electrically connected to a current source CRTS, and another end electrically connected to the second column line CL2. In addition, the bias current circuit 220 may further include a switch SW_5 having one end, electrically connected to the current source CRTS, and another end electrically connected to the first column line CL1.

In one or more embodiments, the power supply voltage circuit 230 may further include a switch SW_6 having one end, applied with the power supply voltage VDD, and another end electrically connected to the first column line CL1. In addition, the power supply voltage circuit 230 may further include a switch SW_7 having one end, applied with the power supply voltage VDD, and another end electrically connected to the second column line CL2.

In one or more embodiments, the switches SW_1, SW_2, SW_3, SW_4, SW_5, SW_6, and SW_7 may be turned on or off based on the control of the timing controller 500 to control an operation mode of the differential amplifier circuit 120. For example, the operation of the image sensor 10 in a low-illuminance environment may be referred to as a first mode. The operation of the image sensor 10 in a high-illuminance environment may be referred to as a second mode.

FIG. 9 is a diagram illustrating the operation of the image sensor 10 according to the embodiment of FIG. 8 in the first mode. Descriptions similar to or overlapping with those provided above are omitted for brevity.

Referring to FIG. 9, in the first mode, switches SW_1, SW_2, SW_3, and SW_4 may be turned on, while switches SW_5, SW_6, and SW_7 may be turned off.

In the first mode, the pixel circuit PX and the readout circuit 200 may correspond to the example of the image sensor 10 illustrated in FIG. 4. The column line CL of FIG. 4 may correspond to the column line CL1 of FIG. 9. A pixel signal Vout output by the pixel circuit PX in the first mode may be referred to as a first pixel signal.

In the first mode, the image sensor 10 may generate a second voltage signal V_RFD input to the differential amplifier circuit 120 within the pixel circuit PX. By increasing the conversion gain of the pixel circuit PX in a low-illuminance environment, the image sensor 10 may improve image quality and enhance image reliability.

FIG. 10 is a diagram illustrating the operation of the image sensor 10 according to the embodiment of FIG. 8 in the second mode. Descriptions similar to or overlapping with those provided above are omitted for brevity.

Referring to FIG. 10, in the second mode, switches SW_5 and SW_7 may be turned on, while switches SW_1, SW_2, SW_3, SW_4, and SW_6 may be turned off.

The first transistor 130 may be turned off, and the voltage of the first node N_FD may be provided to the gate node of the second transistor TX_2. In addition, the fourth transistor TX_4 may be electrically connected to the second column line CL_2 to be electrically connected to the power supply voltage circuit 230, connected to the second column line CL_2, through the switch SW_7. Accordingly, the fourth transistor TX_4 may provide the power supply voltage VDD to the second transistor TX_2.

A pixel signal Vout output by the pixel circuit PX in the second mode may be referred to as a second pixel signal.

The second transistor TX_2 may output the first voltage signal V_FD received through its gate node from the first node N_FD as the second pixel signal Vout to the first column line CL_1 without differential amplification. The first column line CL_1 may be electrically connected to the bias current circuit 220 through switch SW_5 to receive a bias current. The pixel circuit PX may receive the bias current to stably output the second pixel signal Vout through the column line CL_1.

Accordingly, in the embodiment of FIG. 8, in a low-illuminance environment (for example, in the first mode), the first pixel signal Vout obtained by amplifying the second voltage signal V_RFD generated within the pixel circuit PX may be output as illustrated in FIG. 9. As a result, the conversion gain of the image sensor 10 may be increased in the low-illuminance environment to output an image having improved quality in spite of a small amount of optical signal.

In the embodiment of FIG. 8, in a high-illuminance environment (for example, the second mode), sufficient optical signal may already be received, so that an unamplified second pixel signal Vout may be output as illustrated in FIG. 10. Issues such as optical signal saturation and unnecessary power consumption in the high-illuminance environment may be significantly reduced.

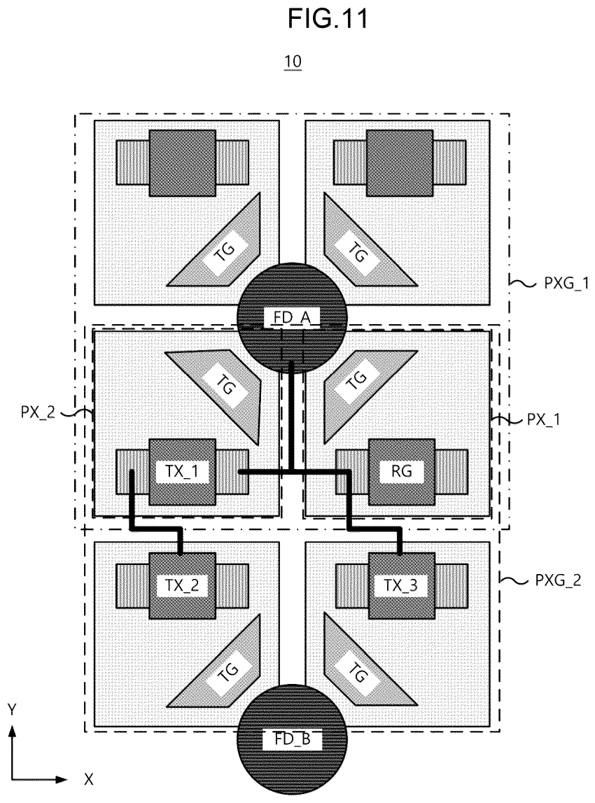

FIG. 11 is a plan view illustrating an image sensor 10 according to one or more embodiments.

Referring to FIG. 11, the image sensor 10 may have four pixel circuits PX forming a single pixel circuit group PXG_1. The pixel circuits PX forming the pixel circuit group PXG_1 may be separated from each other by deep trench isolation DTI.

In one or more embodiments, the pixel circuit group PXG_1 may share a single floating node FD_A. However, each of the pixel circuits PX in the pixel circuit group PXG_1 may individually include a photodiode PD, a transfer transistor TG, or the like.

In one or more embodiments, a first transistor (TX_1) 130, a reset transistor RG, a second transistor TX_2, and a third transistor TX_3 shared by the pixel circuit group PXG_1 may be disposed in another pixel circuit group PXG_2. Accordingly, the length of metal interconnection between the first transistor 130, the reset transistor RG, the second transistor TX_2, and the third transistor TX_3 may be significantly reduced, implementing the pixel circuit group PXG_1 in a small area.

A portion of the four pixel circuits forming the pixel circuit group PXG_2 may include at least one of the first transistor (TX_1) 130, the reset transistor RG, the second transistor TX_2, or the third transistor TX_3 shared by the pixel circuit group PXG_1.

The floating node FD_A, the first transistor (TX_1) 130, the reset transistor RG, the second transistor TX_2, and the third transistor TX_3 may be electrically connected to generate and output the pixel signal Vout of the pixel circuit group PXG_1.

In one or more embodiments, the first transistor (TX_1) 130 may be disposed in the pixel circuit PX closest to the floating node FD_A. For example, the first transistor (TX_1) 130 may be disposed in the pixel circuit PX_2. Alternatively, the first transistor 130 may be disposed in the pixel circuit PX_1.

In one or more embodiments, capacitances at the first node N_FD and the second node N_RFD, respectively corresponding to the drain node and source node of the first transistor 130, may be substantially the same. When the first transistor 130 is turned on, the voltage levels of the first node N_FD and the second node N_RFD in FIG. 4 may be distributed equally.

For example, in FIG. 4, the length of the metal interconnection electrically connecting the first node N_FD and the first transistor AMP_1 may be the same as the length of the metal interconnection electrically connecting the second node N_RFD and the second transistor AMP_2.

However, this is only an example, and the arrangement of the first transistor (TX_1) 130, the reset transistor RG, the transistor TX_1, and the transistor TX_2 shared by the pixel circuit group PXG_1 is not limited thereto.

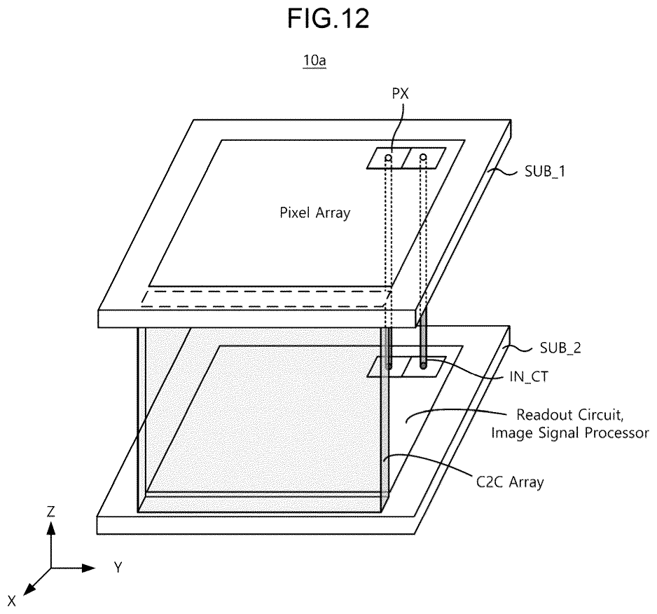

FIG. 12 is a diagram illustrating an image sensor 10a according to one or more embodiments. Descriptions similar to or overlapping with those provided above are omitted for brevity.

The image sensor 10a may include a first substrate SUB_1 and second substrate SUB_2, which are stacked. The first substrate SUB_1 and the second substrate SUB_2 may be electrically connected to each other through a wafer bonding process using Cu-to-Cu (C2C) interconnection. However, this is only an example, and the first substrate SUB_1 and the second substrate SUB_2 may be electrically connected using a through-silicon via TSV.

The first substrate SUB_1 and the second substrate SUB_2 may be electrically connected not only through in-pixel contacts IN_CT within a unit pixel or pixel group PXG but also through a C2C array disposed in a peripheral region of the substrates. Control signals may be transmitted through the C2C array to control the pixel circuit. The pixel signal Vout from the first substrate SUB_1 may be transmitted to the readout circuit 200 or image processing processor of the second substrate SUB_2 through the in-pixel contact IN_CT.

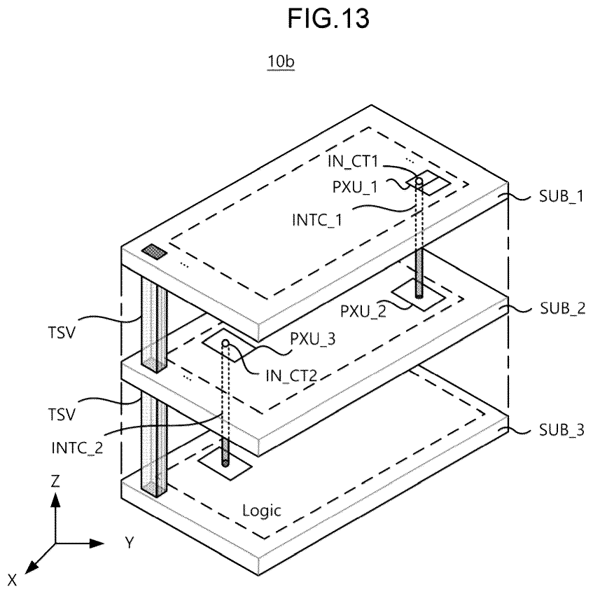

FIG. 13 is a diagram illustrating an image sensor 10b according to one or more embodiments. Descriptions similar to or overlapping with those provided above are omitted for brevity.

Referring to FIG. 13, the image sensor 10b may include a first substrate SUB_1, a second substrate SUB_2, and a third substrate SUB_3. The third substrate SUB_3, second substrate SUB_2, and first substrate SUB_1 may be sequentially stacked in a direction (Z-axis direction) perpendicular to the plane of the substrate (for example, the plane parallel to the X-axis direction and the Y-axis direction).

In one or more embodiments, portions of the pixel circuits PXU_1, PXU_2, PXU_3 may be formed on each of the first substrate SUB_1 and the second substrate SUB_2. The first partial circuit PXU_1 of a pixel group may be disposed on the first substrate SUB_1, while the remaining second partial circuits PXU_2 and PXU_3 of the pixel group may be disposed on the second substrate SUB_2. The third substrate SUB_3 may include a logic circuit such as a readout circuit 200, a timing controller 500, or an image signal processor 300, and an interface circuit.

For example, the photodiode PD and transfer transistor TG may be disposed on the first substrate SUB_1, while the remaining pixel circuits may be disposed on the second substrate SUB_2. For example, the differential amplifier circuit 120 of FIG. 1 may be disposed on the second substrate SUB_2.

However, this is only an example, and the arrangement of pixel circuits on the first substrate SUB_1 and the second substrate SUB_2 is not limited thereto.

The first substrate SUB_1 and the second substrate SUB_2 may be electrically connected to each other.

In one or more embodiments, the first substrate SUB_1 and the second substrate SUB_2 may transmit a pixel signal Vout or a control signal through through-silicon vias TSVs formed in peripheral regions of the substrates.

In one or more embodiments, the first partial circuit PXU_1 of a pixel group on the first substrate SUB_1 and the second partial circuit PXU_2 of a pixel group on the second substrate SUB_2 may be electrically connected through a first inter-substrate connection structure INTC1. The inter-substrate connection structure INTC1 may be a Cu-to-Cu (C2C) bonding contact or deep-contact structure. The deep-contact structure may include a through-silicon via. The inter-substrate connection structure INTC_1 may electrically connect an in-pixel contact IN_CT1, electrically connected to an element of the first partial circuit PXU_1 of the pixel group, and an in-pixel contact IN_CT2 electrically connected to an element of the second partial circuit PXU_2 of the pixel group.

In one or more embodiments, the first substrate SUB_1 and/or the second substrate SUB_2 may be electrically connected to the third substrate SUB_3 through through-silicon vias TSVs and/or a second inter-substrate connection structure INTC_2. Signals from the first substrate SUB_1 and/or the second substrate SUB_2 may be transmitted to a readout circuit 200 or an image signal processor of the third substrate SUB_3 through the through-silicon vias TSVs and/or the second inter-substrate connection structure INTC_2.

In one or more embodiments, the second partial circuit PXU_2 of the pixel group may be electrically connected to circuits on the third substrate SUB_3 through Cu-to-Cu (C2C) bonding contacts. The second inter-substrate connection structure INTC_2 may include Cu-to-Cu (C2C) bonding contacts.

In one or more embodiments, the third partial circuit PXU_3 of the pixel group may be electrically connected to circuits on the third substrate SUB_3 through through-silicon copper TSC.

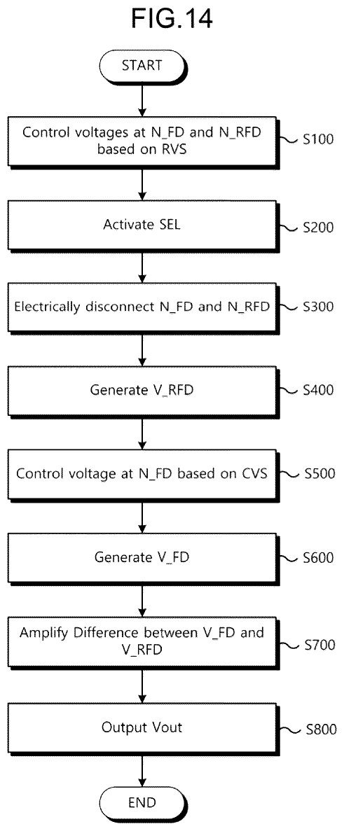

FIG. 14 is a flowchart illustrating the operation of the image sensor 10.

Referring to FIG. 14, in operation S100, the voltages at the first node N_FD and the second node N_RFD may be controlled based on the voltage signal RVS. The reset transistor RG and the first transistor 130 may be in an ON state.

In operation S200, the select signal SEL may be activated, and simultaneously or shortly before or after, the reset transistor RG may be turned off.

In operation S300, the first node N_FD and the second node N_RFD may be electrically disconnected. The first transistor 130 may be in an OFF state.

In operation S400, the second voltage signal V_RFD may be generated. The second voltage signal V_RFD may be the voltage at the second node N_RFD after the first transistor 130 is turned off and a first time has elapsed.

In operation S500, the voltage at the first node N_FD may be controlled based on the voltage signal CVS. The transfer transistor TG may be turned on, and then turned off after a predetermined time has elapsed.

In operation S600, the first voltage signal V_FD may be generated. The first voltage signal V_FD may be the voltage at the first node N_FD after the transfer transistor TG is turned off and a second time has elapsed.

In operation S700, the differential amplifier circuit 120 may amplify the voltage level difference between the first voltage signal V_FD as a first input signal and the second voltage signal V_RFD as a second input signal.

In operation S800, the differential amplifier circuit 120 may output the amplified signal as the pixel signal Vout. The pixel signal Vout may correspond to the first pixel signal.

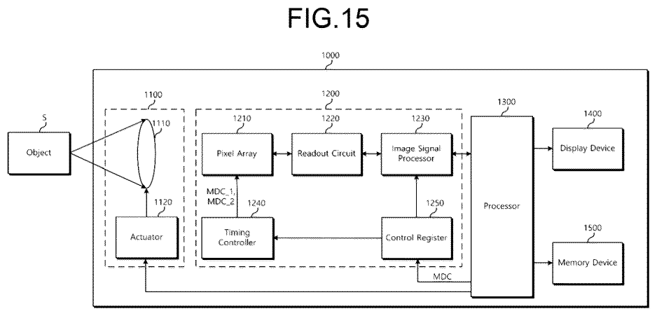

FIG. 15 is a diagram illustrating an imaging device 1000 according to one or more embodiments. Descriptions similar to or overlapping with those provided above are omitted for brevity.

The imaging device 1000 may include an image capturing module 1100, an image sensor 1200, a processor 1300, a display device 1400, and a storage device 1500. The imaging device 1000 may receive an optical signal from an object S, convert the optical signal into image data, and display the image data on the display device 1400 or store the image data in the storage device 1500.

The processor 1300 may control the overall operation of the imaging device 1000. The processor 1300 may provide control signals to the lens driver to control a location of the lens 1110. As a result, a focal length may be controlled.

In the embodiments of FIG. 8 to FIG. 10, the processor 1300 may provide a mode control signal MDC to the control register 1250 to control the switches SW_1, SW_2, SW_3, SW_4, SW_5, SW_6, and SW_7.

However, this is only an example, and the processor 1300 may provide the mode control signal MDC to the timing controller 1240 through the image signal processor 1230, or may directly provide the mode controls signal MDC to the timing controller 1240.

The image capturing module 1100, as a component for receiving optical signals, may include a lens 1110 and an actuator 1120. The lens 1110 may include a plurality of lenses.

The actuator 1120 may move the lens 1110 in a direction, in which a distance increases or decreases from the object S, based on the control signals of the processor 1300.

The image sensor 1200 may generate image data based on the received optical signal. The image sensor 1200 may include a pixel array 1210, a readout circuit 1220, an image signal processor 1230, a timing controller 1240, and a control register 1250.

The pixel circuit PX of the pixel array 1210 may receive an optical signal, convert the optical signal into a pixel signal Vout, and output the pixels signal Vout.

In one or more embodiments, each pixel circuit PX may generate the second voltage signal V_RFD used by the differential amplifier circuit 120 within the pixel circuit PX. Accordingly, the image sensor 1200 may improve PVT reliability, and may significantly reduce the effects of voltage drop and signal interference caused by metal interconnection layers.

The readout circuit 1220 may include an analog-to-digital converter. The analog-to-digital converter included in the readout circuit 1220 may convert the pixel signal Vout into a digital signal Dout and output the digital signal Dout.

The image signal processor 1230 may receive the digital signal Dout and perform image processing to output image data ID to the processor 1300.

The timing controller 1240 may control the operation of the pixel array 1210 based on a mode control signal MDC.

For example, the timing controller 1240 may output a first mode signal MDC_1 to the pixel array 1210 based on the mode control signal MDC. The pixel array 1210 may operate in the first mode.

Alternatively, the timing controller 1240 may output a second mode signal MDC_2 to the pixel array 1210 based on the mode control signal MDC. The pixel array 1210 may operate in the second mode.

The control register 1250 may receive the mode control signal MDC from the processor 1300. The control register 1250 may output the received mode control signal MDC to the timing controller 1240 and/or the image signal processor 1230.

As set forth above, according to embodiments, a pixel circuit and an image sensor may amplify a pixel signal to increase conversion gain.

While various embodiments have been shown and described above, it will be apparent to those skilled in the art that modifications and variations could be made without departing from the scope of the present inventive concept as defined by the appended claims.

At least one of the components, elements, modules, or units (collectively “components” in this paragraph) represented by a block or an equivalent indication in the drawings including FIGS. 1-6, 8-10, and 15 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

What is claimed is:

1. An image sensor comprising:
a pixel array comprising a plurality of pixel circuits configured to convert an optical signal into a pixel signal and output the pixel signal; and
a readout circuit comprising an analog-to-digital conversion circuit configured to convert the pixel signal into digital data and output the digital data, and
wherein each of the plurality of pixel circuits comprises:
a photo detection circuit comprising a photoelectric conversion element, a first node, a transfer transistor configured to electrically connect the photoelectric conversion element and the first node, and a reset transistor configured to electrically connect the first node and a reset voltage node;
a second node connected to the first node through a first transistor; and
a differential amplifier circuit comprising a second transistor comprising a gate terminal connected to the first node, a third transistor comprising a gate terminal connected to the second node, and a fourth transistor connected to a common source node electrically connected to a source node of each of the first transistor and the second transistor.

2. The image sensor of claim 1, wherein the photo detection circuit comprises a plurality of photoelectric conversion elements connected to the first node.

3. The image sensor of claim 1, wherein the first transistor is configured to cause voltage levels of the first node and the second node to be equally distributed based on a capacitance at the first node and a capacitance at the second node.

4. The image sensor of claim 1, wherein the readout circuit further comprises:
an active load circuit connected to the differential amplifier circuit and configured to provide a load resistance to the differential amplifier circuit;
a bias current circuit connected to the differential amplifier circuit and configured to provide a bias current to the differential amplifier circuit; and
a power supply voltage circuit connected to the differential amplifier circuit and configured to provide a power supply voltage to the differential amplifier circuit.

5. The image sensor of claim 4, wherein each of the plurality of pixel circuits is configured to:
output the pixel signal through a first column line;
be electrically connected to the active load circuit through a second column line to selectively receive the load resistance; and
be electrically connected to the bias current circuit and the power supply voltage circuit through a third column line to selectively receive the bias current and the power supply voltage.

6. The image sensor of claim 5, wherein the active load circuit comprises:
a fifth transistor;
a sixth transistor;
a first switch comprising one end electrically connected to the first column line, and another end electrically connected to the fifth transistor; and
a second switch comprising one end connected to the third column line, and another end connected to the sixth transistor.

7. The image sensor of claim 5, wherein the differential amplifier circuit further comprises a third switch comprising one end electrically connected to the third column line, and another end electrically connected to the third transistor.

8. The image sensor of claim 5, wherein the bias current circuit comprises:
a current source configured to provide the bias current;
a fourth switch comprising one end connected to the current source, and another end connected to the second column line; and
a fifth switch comprising one end connected to the current source, and another end connected to the first column line, and
wherein the power supply voltage circuit comprises:
a sixth switch comprising one end applied with the power supply voltage, and another end connected to the first column line; and
a seventh switch comprising one end applied with the power supply voltage, and another end connected to the second column line.

9. An image sensor comprising:
a pixel array comprising a plurality of pixel circuits configured to convert an optical signal into a pixel signal and output the pixel signal;
a readout circuit comprising an analog-to-digital conversion circuit configured to convert the pixel signal into digital data and output the digital data; and
a timing controller configured to control the pixel array based on a mode control signal received from an external device,
wherein each of the plurality of pixel circuits comprises:
a photo detection circuit comprising a photoelectric conversion element, a first node, a reset transistor configured to electrically connect the first node and a reset voltage node, and a transfer transistor configured to electrically connect the photoelectric conversion element and the first node;
a second node connected to the first node through a first transistor; and
a differential amplifier circuit configured to:
in a first mode, receive a first input signal based on a first voltage signal of the first node and a second input signal based on a second voltage signal of the second node and output a first pixel signal based on a difference between the first input signal and the second input signal; and
in a second mode, output the first voltage signal of the first node as a second pixel signal.

10. The image sensor of claim 9, wherein the first transistor is configured to cause voltage levels of the first node and the second node to be equally distributed based on a capacitance at the first node and a capacitance at the second node.

11. The image sensor of claim 9, wherein the second input signal corresponds to a voltage at the second node after a first time being passed since the reset transistor and the first transistor transitioned from turned-on to turned-off.

12. The image sensor of claim 11, wherein the first input signal corresponds to a voltage at the first node after a second time being passed since the transfer transistor transitioned from turned-on to turned-off with the first transistor being turned-off.

13. The image sensor of claim 9, wherein the second pixel signal corresponds to a voltage transferred through a second transistor based on a voltage at the first node after a third time being passed since the transfer transistor transitioned from turned-on to turned-off with the first transistor being turned-off.

14. The image sensor of claim 9, wherein the readout circuit further comprises:
an active load circuit connected to the differential amplifier circuit and configured to provide a load resistance to the differential amplifier circuit;
a bias current circuit connected to the differential amplifier circuit and configured to provide a bias current to the differential amplifier circuit; and
a power supply voltage circuit connected to the differential amplifier circuit and configured to provide a power supply voltage to the differential amplifier circuit.

15. The image sensor of claim 14, wherein each of the plurality of pixel circuits is configured to:
output the first pixel signal or the second pixel signal through a first column line;
be electrically connected to the active load circuit through a second column line to selectively receive the load resistance; and
be electrically connected to the bias current circuit and the power supply voltage circuit through a third column line to selectively receive the bias current and the power supply voltage.

16. The image sensor of claim 15, wherein the differential amplifier circuit is configured, in the first mode, to:
output the first pixel signal through the first column line;
be electrically connected to the bias current circuit through a second column line to receive the bias current; and
be electrically connected to the active load circuit through the first column line and the third column line to receive the load resistance.

17. The image sensor of claim 16, wherein the differential amplifier circuit is configured, in the second mode, to:
output the second pixel signal through the first column line; and
be electrically connected to the power supply voltage circuit through the second column line to receive the power supply voltage.

18. A pixel circuit comprising:
a photo detection circuit comprising a photoelectric conversion element, a first node, a transfer transistor configured to electrically connect the photoelectric conversion element and the first node, and a reset transistor configured to electrically connect the first node and a reset voltage node;
a second node connected to the first node through a first transistor; and
a differential amplifier circuit comprising a second transistor having a gate terminal connected to the first node, a third transistor having a gate terminal connected to the second node, and a fourth transistor connected to a common source node connected to a source node of each of the first transistor and the second transistor.

19. The pixel circuit of claim 18, wherein the differential amplifier circuit is configured to:
receive a first input signal corresponding to a voltage at the first node through the second transistor after the transfer transistor is turned on and then turned off with the first transistor being turned off;
receive a second input signal corresponding to a voltage at the second node through the third transistor after the reset transistor and the first transistor are turned off with the reset transistor and the first transistor being turned on; and
output the pixel signal based on a difference between the first input signal and the second input signal.

20. The pixel circuit of claim 18, wherein the first transistor is configured to cause voltage levels of the first node and the second node to be equally distributed based on a capacitance at the first node and a capacitance at the second node.
